(19) United States
(12) Patent Application Publication
(10) Pub. No.: US 2025/0007637 A1
(43) Pub. Date: Jan. 2, 2025

(54) TIME SYNCHRONIZATION APPARATUS, SYSTEM, AND METHOD

(71) Applicant: BEIJING CHJ INFORMATION TECHNOLOGY CO., LTD., Beijing (CN)

(72) Inventors: Jiafu LIU, Beijing (CN); Yingchun XU, Beijing (CN); Zhengyang GAO, Beijing (CN); Shaodong YANG, Beijing (CN)

(21) Appl. No.: 18/694,866

(22) PCT Filed: Sep. 19, 2022
(86) PCT No.: PCT/CN2022/119691

§ 371 Date: Mar. 22, 2024

(30) Foreign Application Priority Data
Sep. 23, 2021 (CN) 202111115390.3

(51) Int. Cl. H04J 3/06

(52) U.S. Cl. CPC H04J 3/0667

(57) ABSTRACT

An apparatus for time synchronization, configured in a current node, including a message receiving-processing module and a synchronous time determining module, in which an output end of the message receiving-processing module is connected to an input end of the synchronous time determining module; the message receiving-processing module is configured to receive a precision time protocol (PTP) message from a previous node and determine a target parameter according to the PTP message, and the target parameter is a relevant time parameter for representing a time difference between the current node and the previous node; and the synchronous time determining module is configured to determine a synchronous time point of the current node according to the target parameter.

### CROSS-REFERENCE TO RELATED APPLICATIONS

This application is a national phase entry under 35 U.S.C. § 371 of International Application No. PCT/CN2022/119691, filed on Sep. 19, 2022, which claims priority to Chinese Patent Application No. 202111115390.3, filed on Sep. 23, 2021, the entire disclosures of which are incorporated herein by reference.

### TECHNICAL FIELD

The disclosure relates to the field of computer network technologies, and specifically to an apparatus, a system, and a method for time synchronization.

### BACKGROUND

Presently, the conventional solution for achieving time synchronization in the 802.1AS standard in the time sensitive networking (TSN) protocol specification is to receive an event message (such as Pdelay_Req, Pdelay_Resp, or Sync) by a medium access control layer, mark the event message with a timestamp, and send the timestamp to an advanced reduced instruction-set computer (RISC) machine (ARM) platform. Linux™ or Standalone™ may be adopted on the ARM Platform™ and a C or C++ development environment may be used, to calculate parameters such as the link delay, the frequency deviation, and the residence time. However, in the solution, the startup time of the system is long, the implementation cost of the system is high, and the jitter occurs in the transmission process of the event message.

### SUMMARY

An apparatus for time synchronization is provided. The apparatus is configured in a current node. The apparatus includes a message receiving-processing module and a synchronous time determining module. An output end of the message receiving-processing module is connected to an input end of the synchronous time determining module.

The message receiving-processing module is configured to receive a precision time protocol (PTP) message from a previous node and determine a target parameter according to the PTP message, and the target parameter is a relevant time parameter for representing a time difference between the current node and the previous node.

The synchronous time determining module is configured to determine a synchronous time of the current node according to the target parameter.

A system for time synchronization is provided. The system includes a master node, and slave nodes. Each slave node includes: a message receiving-processing module and a synchronous time determining module, in which an output end of the message receiving-processing module is connected to an input end of the synchronous time determining module; the message receiving-processing module is configured to receive a PTP message from a previous node and determine a target parameter according to the PTP message, and the target parameter is a relevant time parameter for representing a time difference between each slave and the previous node; and the synchronous time determining module is configured to determine a synchronous time point of each node according to the target parameter.

A method for time synchronization is provided. The method is performed by a current node. The method includes:
receiving a PTP message from a previous node and determining a target parameter according to the PTP message, in which the target parameter is a relevant time parameter for representing a time difference between the current node and the previous node; and
determining a synchronous time of the current node according to the target parameter.

### BRIEF DESCRIPTION OF THE DRAWINGS

The drawings herein are incorporated into the specification and constitute a part of the specification, show embodiments in conformity with the disclosure, and explain the principle of the disclosure together with the specification.

In order to explain the technical solutions according to embodiments of the disclosure or according to the related art more clearly, the drawings described according to the embodiments or the related art will be briefly introduced below. Obviously, those skilled in the art may obtain other drawings based on the drawings without any creative work.

FIG. 1 is a block diagram illustrating a structure of an apparatus for time synchronization according to embodiments of the disclosure;

FIG. 2 is a detail block diagram illustrating a structure of an apparatus for time synchronization according to embodiments of the disclosure;

FIG. 3 is a diagram illustrating a structure of a message preprocessing unit according to embodiments of the disclosure;

FIG. 4 is a diagram illustrating a logic implementation of a message parsing unit according to embodiments of the disclosure;

FIG. 5 is a diagram illustrating a structure of a target parameter determining unit according to embodiments of the disclosure;

FIG. 6 is a diagram illustrating a transmission process of a PTP message according to embodiments of the disclosure;

FIG. 7 is a block diagram illustrating a structure of another apparatus for time synchronization according to embodiments of the disclosure; and

FIG. 8 is a flowchart illustrating a method for time synchronization according to embodiments of the disclosure.

### DETAILED DESCRIPTION

To understand the above purposes, features, and advantages of the disclosure more clearly, embodiments of the disclosure may be further described below. It should be noted that, embodiments of the disclosure may be combined with features in the embodiments without conflict.

Numerous specific details are set forth in the following description to facilitate a thorough understanding of the disclosure. However, the disclosure may also be implemented in different ways other than those described herein; obviously, embodiments in the specification are only a part of embodiments of the disclosure rather than all embodiments.

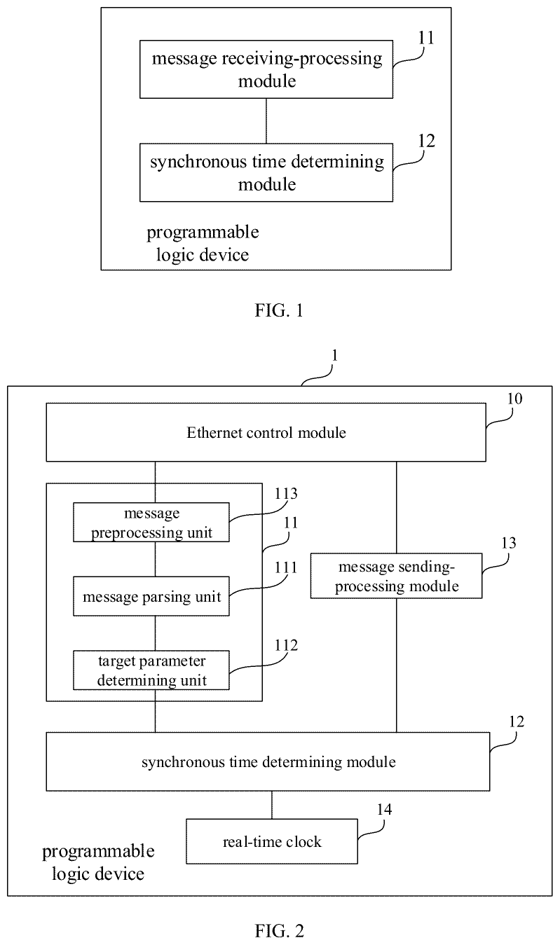

FIG. 1 is a block diagram illustrating a structure of an apparatus for time synchronization according to embodiments of the disclosure. The apparatus for time synchronization may be configured to implement the time synchronization in the TSN 802.1AS and may be configured in a slave node in a vehicle communication network, thereby achieving the time synchronization between the slave node and a master node. The apparatus for time synchronization according to embodiments of the disclosure is configured in a programmable logic device (PLD), that is, modules in the apparatus for time synchronization may be implemented by hardware function modules in the PLD. As shown in FIG. 1, the apparatus for time synchronization includes a message receiving-processing module 11 and a synchronous time determining module 12. An output end of the message receiving-processing module 11 is connected to an input end of the synchronous time determining module 12.

The message receiving-processing module 11 is configured to receive a precision time protocol (PTP) message from a previous node and determine a target parameter according to the PTP message. The target parameter is a relevant time parameter for representing a time difference between the current node and the previous node.

The synchronous time determining module 12 is configured to determine a synchronous time of the current node according to the target parameter.

The apparatus for time synchronization according to embodiments of the disclosure is applied in a node in a PTP domain, that is, a clock node, for example, a switch supporting a PTP protocol. The node device in the PTP domain performs a clock synchronization according to a certain master-slave relationship. The node device that synchronizes a clock is called a slave node and the node device that publishes the clock is called a master node. The master-slave relationship is relative. One node device may synchronize the clock from an upper node device and publish the clock to a lower node device simultaneously. According to embodiments of the disclosure, clock information is transmitted via the PTP message. The clock node according to embodiments of the disclosure may be a boundary clock, that is, a clock with two or more PTP communication ports. The two or more PTP communication ports include a master port that publishes the synchronous time and a slave port that receives the synchronous time. According to embodiments of the disclosure, when the current node is a slave node directly connected to the master node, the previous node is the master node; and when the current node is a slave node not directly connected to the master node, the previous node is the slave node.

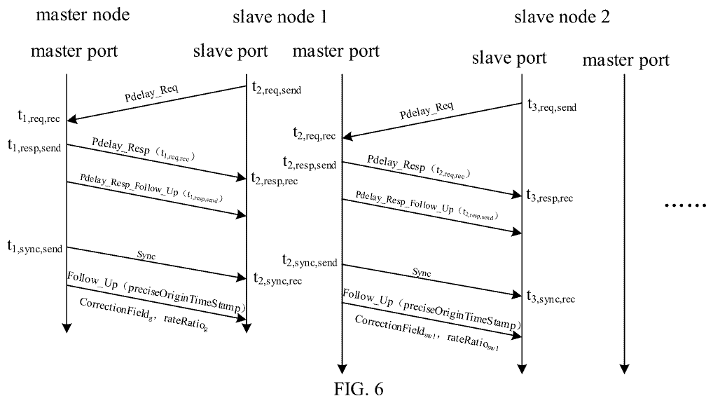

In addition, the PTP message includes an event message and a general message. The event message is a time-concept message marked with a precise timestamp when entering and leaving a device port, and may include a synchronization message (Sync), a delay request message (Delay_Req), a point delay request message (Pdelay_Req), a point delay response message (Pdelay_Resp), and the like. The general message is a non-time-concept message that will not generate a timestamp when sent to or output from a device port. The general message is configured to establish a master-slave relationship, and request and announce time information. The general message includes an announcement message (Announce), a follow-up message (Follow_Up), a delay response message (Delay_Resp), a point delay response follow-up message (Pdelay_Resp_Follow_Up), a management message (Management), a signal message (Signaling), and the like. In the above PTP message, the Sync is used to synchronize a message and sent from the master node to the slave node and may include a timestamp when the Sync is sent, and the timestamp may be included in a subsequent Follow_Up. The Delay_Req is used to request an opposite point to return a timestamp when the Delay_Req is received, and the timestamp is embedded in the Delay_Resp. The Pdelay_Req is used to initiate a measurement request of a link delay, including a timestamp when the Pdelay_Req is sent. The Pdelay_Resp is used to respond to the Pdelay_Req, and may include a timestamp when the Pdelay_Resp is sent, and the timestamp may be included in a subsequent Pdelay_Resp_Follow_Up. The Announce is used to broadcast state and feature information of a sending node and an advanced master clock. The Follow_Up is used to send a timestamp when the Sync is sent. The Pdelay_Resp_Follow_Up is used to send a timestamp when the Pdelay_Resp is sent. The Management is used to send information and a command for managing a clock device. The Signaling is used to send information, a request, and a command among different clocks. According to embodiments of the disclosure, the PTP message may include Sync, Follow_Up, Pdelay_Req, Pdelay_Resp, and Pdelay_Resp_Follow_Up. For example, the previous node sends the Sync to the current node (when the previous node is a slave node, the previous node forwards the Sync from the master node to the current node), and when receiving the Sync, the current node obtains a timestamp when the Sync is received. When the Sync does not include a timestamp when the previous node sends the Sync, the previous node continues to send the Follow_Up to the current node, and when receiving the Follow_Up, the current node obtains a timestamp when the previous node sends the Sync from the Follow_Up. The current node sends the Pdelay_Req to the previous node, and obtains a timestamp when the Pdelay_Req is sent simultaneously. The previous node sends the Pdelay_Resp to the current node when receiving the Pdelay_Req, and when receiving the Pdelay_Resp, the current node obtains a timestamp when the Pdelay_Resp is received, and obtains a timestamp when the previous node receives the Pdelay_Req from the Pdelay_Resp. When the Pdelay_Resp does not include the timestamp when the previous node sends the Pdelay_Resp, the previous node continues to send the Pdelay_Resp_Follow_Up to the current node, and when receiving the Pdelay_Resp_Follow_Up, the current node obtains the timestamp when the previous node sends the Pdelay_Resp from the Pdelay_Resp_Follow_Up (Refer to FIG. 6).

In the above solutions, the PLD may be a field programmable gate array (FPGA). In addition, the PLD may further include an Ethernet control module. The Ethernet control module may be an Ethernet controller, an input end of the Ethernet control module is connected to an Ethernet transceiver (Phy), and the Ethernet control module is configured to receive and send the PTP message and add a hardware timestamp on the event message in the PTP message.

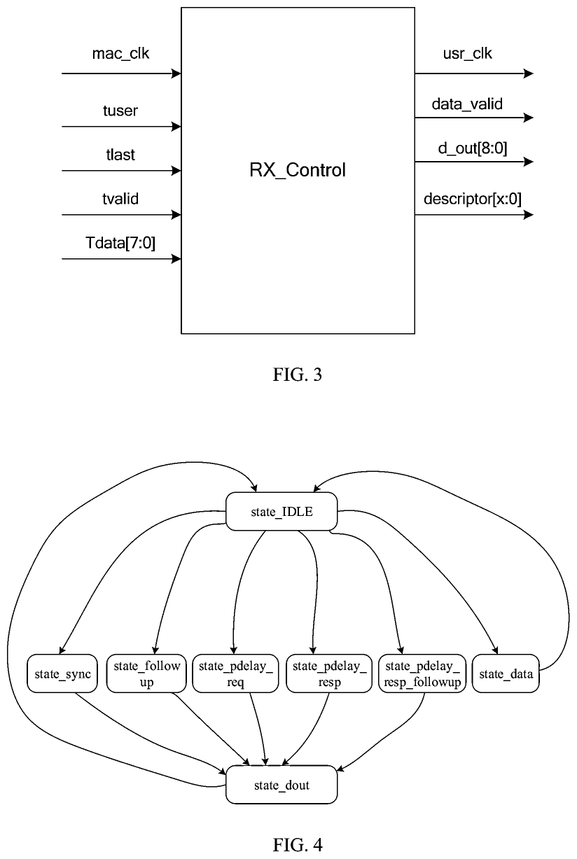

Based on the above technical solutions, according to some embodiments, referring to FIG. 2, the message receiving-processing module 11 includes a message preprocessing unit 113. An input end of the message preprocessing unit 113 is connected to an output end of the Ethernet control module 10. The message preprocessing unit 113 is configured to receive the PTP message from the previous node and perform a clock domain conversion on the PTP message. Considering different processing logics of the PLD for different bandwidth interfaces, when the bandwidth interface is replaced, the processing logic of the PLD need to be adjusted. Therefore, in the disclosure, the message preprocessing unit 113 performs the clock domain conversion on the PTP message, so that when the bandwidth interface is replaced, the processing logic of the PLD remains unchanged. As shown in FIG. 3, the message preprocessing unit RX_Control performs the clock domain conversion on the PTP message, that is, mac_clk is converted to usr_clk. The mac_clk represents a clock at a media access control (MAC) sublayer protocol end, and the usr_clk represents a clock at a user side. At the same time, the message preprocessing unit RX_Control may further expand a bit width of received message data. For example, 8-bit wide data is expanded to 9-bit wide data, that is, a bit width expansion is performed on 8-bit wide data tdata[7:0] to obtain 9-bit wide data d_out[8:0]. One bit of data is added to a high bit to indicate start and end of a frame. In addition, in the message preprocessing unit RX_Control shown in FIG. 3, tuser indicates whether each frame of received message data is an abnormal frame, tlast indicates an end flag bit of the frame, tvalid indicates whether each byte in each frame is valid, data_valid indicates validity of output message data, and descriptor[x:0] indicates a PTP message descriptor with a bit width of x+1 for indicating a message type.

According to some embodiments, referring to FIG. 2, the message receiving-processing module 11 further includes a message parsing unit 111. An input end of the message parsing unit 111 is connected to an output end of the message preprocessing unit 113. The message parsing unit 111 is configured to obtain a key parameter of the PTP message by parsing the PTP message after the clock domain conversion. The key parameter of the PTP message is a time parameter carried by the PTP message.

According to some embodiments, the message parsing unit 111 is specifically configured to, obtain a PTP message descriptor; determine a message type according to the PTP message descriptor; and extract the key parameter of the PTP message corresponding to the message type from the PTP message. According to some embodiments, the key parameter of the PTP message includes a synchronization message sending timestamp, a synchronization message receiving timestamp, a synchronization follow-up message time parameter, a point delay request message sending timestamp, a point delay request message receiving timestamp, a point delay response message sending timestamp, and a point delay response message receiving timestamp. In detail, the message parsing unit 111 may be implemented by a design of a state machine. As shown in FIG. 4, when the PTP message descriptor is sync, it is determined that the message type is Sync. An initial state state_IDLE is skipped to a state state_sync, and the key parameter of the PTP message corresponding to the Sync is obtained, for example, a timestamp when the previous node sends the Sync, that is, a synchronization message sending timestamp, and a time stamp when the current node receives the Sync, that is, a synchronization message receiving timestamp. Then, the state_sync is skipped to a state_dout, the key parameter of the PTP message corresponding to the Sync is output, and the initial State state_IDLE is returned. When the PTP message descriptor is followup, it is determined that the message type is Follow_Up. The initial state state_IDLE is skipped to the state state_followup, and the key parameter of the PTP message corresponding to Follow_Up is obtained, for example, the synchronization follow-up message time parameter, which specifically includes a precise time OriginTimeStamp of the master node, a preset correction time CorrectionFieldg, and a preset frequency deviation ratio rateRatiog. Then, the state is skipped to a state state_dout, the key parameter of the PTP message corresponding to Follow_Up is output, and the initial state state_IDLE is returned. When the PTP message descriptor is pdelay_req, it is determined that the message type is Pdelay_Req. The initial state state_IDLE is skipped to the state state_pdelay_req, and the key parameter of the PTP message corresponding to Pdelay_Req is obtained, for example, the timestamp when the current node sends Pdelay_Req, that is, a point delay request message sending timestamp. Then, the state is skipped to the state state_dout, the key parameter of the PTP message corresponding to Pdelay_Req is output, and the initial state state_IDLE is returned. When the PTP message descriptor is pdelay_resp, it is determined the message type is Pdelay_Resp, and the initial state state_IDLE is skipped to State pdelay_resp, and the key parameter of the PTP message corresponding to Pdelay_Resp is output, for example, the timestamp when the previous node receives Pdelay_Req, that is, a point delay request message receiving timestamp, and the timestamp when the current node receives Pdelay_Resp, that is, a point delay response message receiving timestamp. Then the state is skipped to the state state_dout, the key parameter of the PTP message corresponding to Pdelay_Resp is output, and the initial state state_IDLE is returned. When the PTP message descriptor is pdelay_resp_followup, it is determined that the message type is Pdelay_Resp_Follow_Up. The initial state state_IDLE is skipped to a state state_pdelay_resp_followup, and the key parameter of the PTP message corresponding to Pdelay_Resp_Follow_Up is obtained, for example, the timestamp when the previous node sends the Pdelay_Resp in response to the Pdelay_Req, that is, a point delay response message sending timestamp. Then, the state is skipped to the state state_dout, and the key parameter of the PTP message corresponding to Pdelay_Resp_Follow_Up is obtained, and the initial state state_IDLE is returned. When the PTP message descriptor is send_data, the initial state state_IDLE is skipped to the state state_data, and the initial state state_IDLE is directly returned. Based on the design of the above state machine, the parsing of the PTP message is achieved, and the key parameter of the PTP message such as each time stamp is extracted.

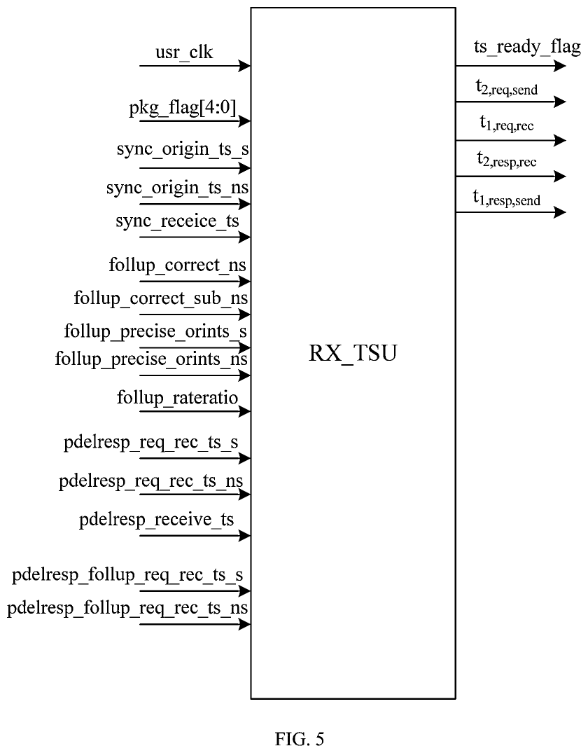

According to some embodiments, continuing to refer to FIG. 2, the message receiving-processing module 11 further includes a target parameter determining unit 112. An input end of the target parameter determining unit 112 is connected to an output end of the message parsing unit 111. The target parameter determining unit 112 is configured to determine the target parameter according to the key parameter of the PTP message. According to some embodiments, the target parameter includes a point delay request sending time of the current node, a point delay request receiving time of the previous node, a point delay response sending time of the previous node, and a point delay response receiving time of the current node. FIG. 5 is a diagram illustrating a structure of a target parameter determining unit. As shown in FIG. 5, the key parameter of the PTP message is input into the target parameter determining unit RX_TSU, and the target parameter determining unit RX_TSU extracts a target timestamp related to the target parameter from the key parameter of the PTP message, and determines the target parameter according to the target timestamp. In detail, the target timestamp includes a point delay request message sending timestamp, a point delay request message receiving timestamp, a point delay response message sending timestamp, and a point delay response message receiving timestamp. The target parameter determining unit RX_TSU outputs a point delay request message sending time t2,req,send of the current node, a point delay request message receiving time t1,req,rec of the previous node, a point delay response message sending time t1,resp,send of the previous node, and a point delay response message receiving time t2,resp,rec of the current node, and outputs a valid identifier ts_ready_flag. The valid identifier ts_ready_flag indicates whether the point delay request message sending time t2,req,send of the current node, the point delay request message receiving time t1,req,rec of the previous node, the point delay response message sending time t1,resp,send of the previous node, and the point delay response message receiving time t2,resp,rec of the current node are valid. For example, when the valid identifier ts_ready_flag is 1, it indicates valid, and when the valid identifier ts_ready_flag is 0, it indicates invalid.

According to some embodiments, continuing to refer to FIG. 2, the PLD may further include a message sending-processing module 13. An input end of the message sending-processing module 13 is connected to an output end of the synchronous time determining module 12. An output end of the message sending-processing module 13 is connected to an input end of the Ethernet control module 10. After the synchronous time determining module 12 determines the synchronous time, the message sending-processing module 13 sends a PTP message to a secondary slave node (a latter node), so that the time synchronization is performed on the latter node and the master node. In addition, the PLD may further include a real-time clock 14. The real-time clock 14 is configured to update a local clock periodically to achieve the time synchronization.

According to some embodiments, the synchronous time determining module is configured to, determine a correction time of the previous node according to the target parameter, a preset correction time, and a preset frequency deviation ratio, in which the correction time of the previous node is a duration of transmission and residence in a network link when a synchronization message is received by the previous node and the synchronization message is forwarded by the previous node; determine a link transmission delay between the previous node and the current node and a frequency deviation ratio of the current node according to the target parameter and the preset frequency deviation ratio, in which the frequency deviation ratio of the current node is a ratio between a clock frequency of the current node and a clock frequency of the previous node; and determine the synchronous time according to a precise time of the master node, the correction time of the previous node, the link transmission delay, and the frequency deviation ratio of the current node.

In detail, referring to FIG. 6, the synchronous time is calculated based on the following equation:

$$GlobtalTime ( t ) = preciseOriginTimeStamp + {CorrectionField}_{sw ( i - 1 )} + {Pdelay}_{swi} + R a t e R a t i {o}_{swi} * ( t - {t}_{i , sync , rec} ) ;$$

where, preciseOriginTimeStamp is the precise time of the master node, CorrectionField_{sw(i-1)} is the correction time of the previous node, Pdelay_{swi} is the link transmission delay, RateRatio_{swi} is the frequency deviation ratio of the current node, and t is time of the current node.

In the above equation, CorrectionField_{sw1}=CorrectionField_{g}+_{del} CorrectionField_{sw1}

$${}_{del} {CorrectionField}_{sw 1} = ( {t}_{2 , sync , send} - {t}_{2 , sync , rec} ) * r a t e R a t i {o}_{s w 1} + \frac{n e i g h b o r P r o p D e l a {y}_{s w 1}}{n e i g h b o r R a t e R a t i {o}_{s w 1}} * {rateRatio}_{{sw}_{1}} , {neighborRateRatio}_{sw 1} = ( {( {t}_{1 , resp , send} )}_{n} - {( {t}_{1 , resp , s e n d} )}_{n - 1} ) / ( {( {t}_{2 , resp , rec} )}_{n} - {( {t}_{2 , resp , rec} )}_{n - 1} ) , {neighborPropDelay}_{s w 1} = [ n e i g h b o r R a t e R a t i {o}_{s w 1} * ( {t}_{2 , resp , rec} - {t}_{2 , r e q , s e n d} ) - ( {t}_{1 , req , rec} - {t}_{1 , resp , send} ) ] / 2 , {Pdelay}_{s w 1} = n e i g h b o r P r o p D e l a {y}_{s w 1} * r a t e R a t i {o}_{g} , R a t e R a t i {o}_{s w 1} = r a t e R a t i {o}_{g} + n e i g h b o r R a t e R a t i {o}_{s w 1} - 1.$$

The synchronous time of the current node may be calculated based on the above equation. It may be understood that, the above equation is illustrated by taking a slave node 1 in FIG. 1 for example. When the synchronous time of the secondary slave node is calculated, the current slave node may be taken as the master node. For example, when the synchronous time of a slave node 2 is calculated, the slave node 1 may be taken as the master node.

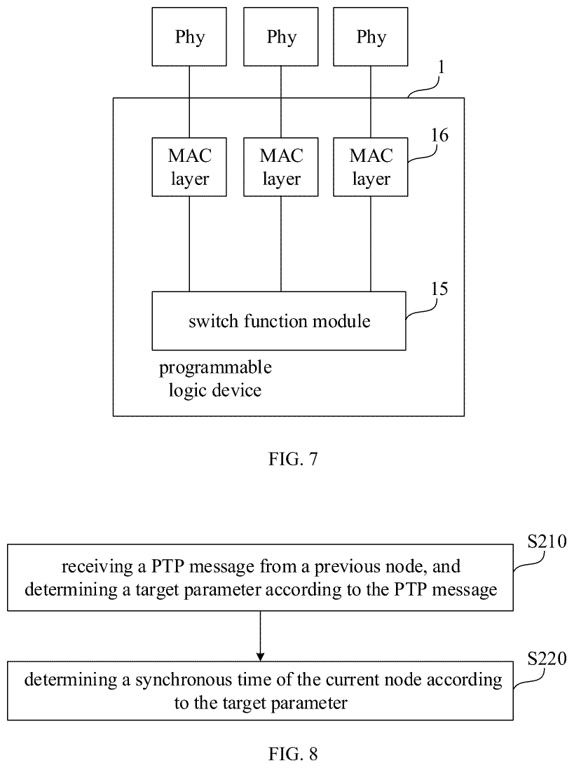

According to some embodiments, the PLD implements a design of a switch. As shown in FIG. 7, the PLD may further include a switch function module 15. The Ethernet control module 10, the message receiving-processing module 11, the synchronous time determining module 12, and the message sending-processing module 13 in the above embodiments are applicable to a MAC layer 16.

According to some embodiments, the Ethernet control module, the message receiving-processing module, and the synchronous time determining module work in parallel. In this way, reception of the PTP message, parsing of the PTP message, and calculation of the synchronous time may be performed in parallel, which greatly enhances a computing speed and stability of a computing process.

In the apparatus for time synchronization according to embodiments of the disclosure, the PTP message from the previous node is received, the target parameter is determined according to the PTP message, and the synchronous time of the current node is determined according to the target parameter. All are implemented by adopting hardware function modules at the PLD side, that is, an entire process of time synchronization adopts “hard implementation”, which reduces the startup time of the Linux™ system or the Standalone™ system, so that the startup time of the entire system is reduced, the participation of the ARM Platform™ is avoided, and the implementation cost of the entire system is reduced. At the same time, the event message may be sent strictly according to a clock cycle of the PLD itself, so as to ensure the determinacy of the transmission time of the event message and avoid the jitter in the transmission of the event message.

A system for time synchronization is provided according to embodiments of the disclosure, and includes a master node, at least one slave node, and the apparatus for time synchronization according to any one of embodiments of the disclosure. The apparatus for time synchronization is configured in the slave node.

The system for time synchronization according to embodiments of the disclosure includes the apparatus for time synchronization according to any one of embodiments of the disclosure, and has same functions and beneficial effects.

A method for time synchronization is provided according to embodiments of the disclosure, and is performed by the apparatus for time synchronization according to any one of embodiments of the disclosure. As shown in FIG. 8, the method includes following steps.

At S210, a PTP message from a previous node is received, and a target parameter is determined according to the PTP message.

According to some embodiments, determining the target parameter according to the PTP message includes: receiving the PTP message from the previous node and performing a clock domain conversion on the PTP message; obtaining a key parameter of the PTP message by parsing the PTP message after the clock domain conversion, in which the key parameter of the PTP message is a time parameter carried by the PTP message; and determining the target parameter according to the key parameter of the PTP message.

In detail, obtaining the key parameter of the PTP message by parsing the PTP message after the clock domain conversion includes: obtaining a PTP message descriptor; determining a message type according to the PTP message descriptor; and extracting the key parameter of the PTP message corresponding to the message type from the PTP message.

According to some embodiments, determining the target parameter according to the key parameter of the PTP message specifically includes: extracting a target timestamp related to the target parameter from the key parameter of the PTP message; and determining the target parameter according to the target timestamp.

According to some embodiments, the key parameter of the PTP message includes a synchronization message sending timestamp, a synchronization message receiving timestamp, a synchronization follow-up message time parameter, a point delay request message sending timestamp, a point delay request message receiving timestamp, a point delay response message sending timestamp, and a point delay response message receiving timestamp. The target parameter includes a point delay request sending time of the current node, a point delay request receiving time of the previous node, a point delay response sending time of the previous node, and a point delay response receiving time of the current node.

At S220, a synchronous time of the current node is determined according to the target parameter.

According to some embodiments, determining the synchronous time of the current node according to the target parameter includes: determining a correction time of the previous node according to the target parameter, a preset correction time, and a preset frequency deviation ratio, in which the correction time of the previous node is a duration of transmission and residence in a network link from after a synchronization message is sent by the master node to before the synchronization message is forwarded by the previous node; determining a link transmission delay between the previous node and the current node and a frequency deviation ratio of the current node according to the target parameter and the preset frequency deviation ratio, in which the frequency deviation ratio of the current node is a ratio of a clock frequency of the current node to a clock frequency of the master node; and determining the synchronous time according to a precise time of the master node, the correction time of the previous node, the link transmission delay, and the frequency deviation ratio of the current node.

The method for time synchronization according to embodiments of the disclosure and the apparatus for time synchronization according to embodiments of the disclosure belong to a general invention conception, and content not described in method embodiments for time synchronization may refer to apparatus embodiments for time synchronization, which will not be repeated herein.

An electronic device is further provided according to embodiments of the disclosure. The electronic device includes at least one processor; and a memory communicatively connected to the at least one processor; the memory is configured to store instructions executable by at least one processor, and when the instructions are executed by least one processor, at least one processor is caused to perform the method for time synchronization according to the above any one embodiment.

A non-transitory computer-readable storage medium stored with computer instructions is provided according to embodiments of the disclosure. The computer instructions are configured to cause a computer to perform the method for time synchronization according to any one of the above embodiments.

A computer program product including a computer program is provided according to embodiments of the disclosure. The computer program is configured to perform the method for time synchronization according to any one of the above embodiments when performed by a processor.

A computer program including a computer program code is provided according to embodiments of the disclosure. When the computer program code is running on a computer, the computer is caused to perform the method for time synchronization according to any one of the above embodiments.

It needs to be noted that, the foregoing explanation of apparatus embodiments and method embodiments for time synchronization is applicable to the electronic device, the computer-readable storage medium, the computer program product, and the computer program according to the above embodiments, which will not be repeated herein.

It needs to be noted that, the terms “comprise”, “include”, or any other variations thereof, are intended to cover anon-exclusive inclusion, such that a process, a method, an article, or a device including a series of elements not only includes those elements but also includes other elements not expressly listed, or may further include elements inherent to such process, method, article, or device. In the absence of more constraints, the elements defined by a sentence “comprising one” do not preclude the presence of additional same elements in the process, method, article, or apparatus that includes the elements.

The foregoing is merely specific embodiments of the disclosure, so that those skilled in the art may understand or implement the disclosure. Various modifications to the embodiments will be apparent to those skilled in the art, and general principles defined herein may be implemented in other embodiments without departing from the spirit or scope of the disclosure. Therefore, the disclosure may not be limited to the embodiments described herein, but conform to the widest scope consistent with principles and novel features disclosed herein.

All embodiments of the disclosure may be executed separately or in combination with other embodiments, and are deemed within a protection scope of the disclosure.

1. An apparatus for time synchronization, configured in a current node, comprising a message receiving-processing module and a synchronous time determining module, wherein an output end of the message receiving-processing module is connected to an input end of the synchronous time determining module;
wherein the message receiving-processing module is configured to receive a precision time protocol (PTP) message from a previous node and determine a target parameter according to the PTP message, and the target parameter is a relevant time parameter for representing a time difference between the current node and the previous node; and
the synchronous time determining module is configured to determine a synchronous time of the current node according to the target parameter.

2. The apparatus according to claim 1, wherein the message receiving-processing module comprises a message preprocessing unit, wherein the message preprocessing unit is configured to receive the PTP message from the previous node and perform a clock domain conversion on the PTP message.

3. The apparatus according to claim 2, wherein the message receiving-processing module further comprises a message parsing unit, wherein an input end of the message parsing unit is connected to an output end of the message preprocessing unit; and
the message parsing unit is configured to obtain a key parameter of the PTP message by parsing the PTP message after the clock domain conversion, wherein the key parameter of the PTP message is a time parameter carried by the PTP message.

4. The apparatus according to claim 3, wherein the message parsing unit is configured to obtain the key parameter of the PTP message by parsing the PTP message after the clock domain conversion, by performing:
obtaining a PTP message descriptor;
determining a message type according to the PTP message descriptor; and
extracting the key parameter of the PTP message corresponding to the message type from the PTP message.

5. The apparatus according to claim 3, wherein the message receiving-processing module further comprises a target parameter determining unit, wherein an input end of the target parameter determining unit is connected to an output end of the message parsing unit; and
the target parameter determining unit is configured to determine the target parameter according to the key parameter of the PTP message.

6. The apparatus according to claim 5, wherein the target parameter determining unit is configured to:
extract a target timestamp related to the target parameter from the key parameter of the PTP message; and
determine the target parameter according to the target timestamp.

7. The apparatus according to claim 3, wherein the key parameter of the PTP message comprises a synchronization message sending timestamp, a synchronization message receiving timestamp, a synchronization follow-up message time parameter, a point delay request message sending timestamp, a point delay request message receiving timestamp, a point delay response message sending timestamp, and a point delay response message receiving timestamp; and the target parameter comprises a point delay request sending time of the current node, a point delay request receiving time of the previous node, a point delay response sending time of the previous node, and a point delay response receiving time of the current node.

8. The apparatus according to claim 1, wherein the synchronous time determining module is configured to:
determine a correction time of the previous node according to the target parameter, a preset correction time, and a preset frequency deviation ratio, wherein the correction time of the previous node is a duration of transmission and residence in a network link when a synchronization message is received by the previous node and is forwarded by the previous node;
determine a link transmission delay between the previous node and the current node and a frequency deviation ratio of the current node according to the target parameter and the preset frequency deviation ratio, wherein the frequency deviation ratio of the current node is a ratio between a clock frequency of the current node and a clock frequency of the previous node; and
determine the synchronous time according to a precise time of the previous node, the correction time of the previous node, the link transmission delay, and the frequency deviation ratio of the current node.

9. The apparatus according to claim 1, wherein the apparatus for time synchronization is configured by a programmable logic device (PLD).

10. A system for time synchronization, comprising a master node; and slave nodes, wherein each slave node comprises:
a message receiving-processing module and a synchronous time determining module, wherein an output end of the message receiving-processing module is connected to an input end of the synchronous time determining module;
wherein the message receiving-processing module is configured to receive a precision time protocol (PTP) message from a previous node and determine a target parameter according to the PTP message, and the target parameter is a relevant time parameter for representing a time difference between each node and the previous node; and
the synchronous time determining module is configured to determine a synchronous time of each node according to the target parameter.

11. A method for time synchronization, performed by a current node, comprising:
receiving a precision time protocol (PTP) message from a previous node and determining a target parameter according to the PTP message, wherein the target parameter is a relevant time parameter for representing a time difference between the current node and the previous node; and
determining a synchronous time of the current node according to the target parameter.

12. The method according to claim 11, wherein receiving the PTP message from the previous node and determining the target parameter according to the PTP message comprises:
receiving the PTP message from the previous node and performing a clock domain conversion on the PTP message.

13. The method according to claim 12, wherein receiving the PTP message from the previous node and determining the target parameter according to the PTP message further comprises:
obtaining a key parameter of the PTP message by parsing the PTP message after the clock domain conversion, wherein the key parameter of the PTP message is a time parameter carried by the PTP message.

14. The method according to claim 13, wherein obtaining the key parameter of the PTP message by parsing the PTP message after the clock domain conversion comprises:
obtaining a PTP message descriptor;
determining a message type according to the PTP message descriptor; and
extracting the key parameter of the PTP message corresponding to the message type from the PTP message.

15. The method according to claim 13, further comprising:
determining the target parameter according to the key parameter of the PTP message.

16. The method according to claim 15, wherein determining the target parameter according to the key parameter of the PTP message comprises:
extracting a target timestamp related to the target parameter from the key parameter of the PTP message; and
determining the target parameter according to the target timestamp.

17. The method according to claim 13, wherein the key parameter of the PTP message comprises a synchronization message sending timestamp, a synchronization message receiving timestamp, a synchronization follow-up message time parameter, a point delay request message sending timestamp, a point delay request message receiving timestamp, a point delay response message sending timestamp, and a point delay response message receiving timestamp; and the target parameter comprises a point delay request sending time of the current node, a point delay request receiving time of the previous node, a point delay response sending time of the previous node, and a point delay response receiving time of the current node.

18. The method according to claim 11, wherein determining the synchronous time of the current node according to the target parameter comprises:
determining a correction time of the previous node according to the target parameter, a preset correction time, and a preset frequency deviation ratio, wherein the correction time of the previous node is a duration of transmission and residence in a network link when a synchronization message is received by the previous node and is forwarded by the previous node;
determining a link transmission delay between the previous node and the current node and a frequency deviation ratio of the current node according to the target parameter and the preset frequency deviation ratio, wherein the frequency deviation ratio of the current node is a ratio between a clock frequency of the current node and a clock frequency of the previous node; and
determining the synchronous time according to a precise time of the previous node, the correction time of the previous node, the link transmission delay, and the frequency deviation ratio of the current node.

19.-22. (canceled)
